(19) United States
(12) Patent Application Publication
(10) Pub. No.: US 2023/0360356 A1
(43) Pub. Date: Nov. 9, 2023

(54) COMPUTER VISION PLATFORM FOR BUILDING A DIGITAL REPRESENTATION OF PHYSICAL OBJECTS AND RESPONDING TO EVENTS AND STATE CHANGES INVOLVING THE PHYSICAL OBJECTS

(71) Applicant: KIBSI, INC., Irvine, CA (US)

(72) Inventors: Amir KASHANI, Irvine, CA (US); Tolga TARHAN, Irvine, CA (US); Paul DUFFY, Lake Forest, CA (US)

(21) Appl. No.: 17/736,013

(22) Filed: May 3, 2022

(51) Int. Cl. G06V 10/20; G06V 10/22; G06V 10/62

(52) U.S. Cl. CPC G06V 10/255; G06V 10/235; G06V 10/62

(57) ABSTRACT

A computer vision platform generates and maintains a digital representation of physical objects in a physical space, where the digital representation comprises objects corresponding to the physical objects and the objects comprise attributes. The attributes can include enhancer attributes, expression attributes, and state machine attributes that are specified by a user during a configuration process. In one embodiment, the computer vision platform comprises a video runtime module, a detector runtime module, an application runtime module, and an aggregation module. The video runtime module captures and processes video streams into video frames. The detector runtime module identifies and tracks physical objects and attributes in the video frames. The application runtime module builds a digital representation of objects corresponding to the physical objects, derives additional data from user-defined attributes, and builds relationships between disparate physical objects. The aggregation module generates a dashboard, alerts, reports, APIs, and/or other output to inform the user of the identified events and state changes.

### FIELD OF THE INVENTION

A computer vision platform generates and maintains a digital representation for tracking physical objects, where the digital representation comprises objects corresponding to the physical objects and the objects comprise attributes, and the computer vision platform informs a user about relevant events and state changes involving attributes of the physical objects.

### BACKGROUND OF THE INVENTION

Cameras are increasingly supporting tasks previously only accomplished by specialized sensors. Tremendous improvements have been made in pixel resolution, frame rate, and color and contrast capture in cameras. This benefits other, related technologies as well, such as computer vision.

Prior art computer vision technologies include software for obtaining data from video cameras and performing analysis of the data. These prior art solutions typically are customized for a specific site and task and require model training specifically for that project. These solutions are expensive and lack the flexibility to work with any physical space or context.

What is needed is a computer vision platform that can detect and track physical objects using a library of primitives, represent the physical objects in a digital format, and generate an output in response to events involving the physical objects.

### SUMMARY OF THE INVENTION

A computer vision platform generates and maintains a digital representation for tracking physical objects, where the digital representation comprises objects corresponding to the physical objects and the objects comprise attributes. The attributes can include enhancer attributes, expression attributes, and state machine attributes that are specified by a user during a configuration process. In one embodiment, the computer vision platform comprises a video runtime module, a detector runtime module, an application runtime module, and an aggregation module. The video runtime module captures and processes video streams into video frames. The detector runtime module identifies and tracks physical objects and attributes in the video frames. The application runtime module builds a digital representation of objects corresponding to the physical objects, derives additional data from user-defined attributes, and builds relationships between disparate physical objects. The aggregation module generates a dashboard, alerts, reports, APIs, and/or other output to inform the user of the identified events and state changes.

### BRIEF DESCRIPTION OF THE DRAWINGS

FIG. 1 depicts prior art hardware components of a computing device.

FIG. 2 depicts software components of a computing device.

FIG. 3 depicts a client computing device communicating with a server computing device over a network.

FIG. 4 depicts a computer vision platform.

FIG. 5 depicts additional detail for the computer vision platform.

FIG. 6 depicts a video capture configuration method.

FIG. 7 depicts a detector configuration method.

FIG. 8 depicts an application configuration method.

FIG. 9 depicts attributes for an object.

FIG. 10 depicts a state machine.

FIG. 11 depicts an aggregation configuration method.

FIG. 12 depicts an output from an aggregation module.

FIGS. 13A to 13E depict operation of a computer vision platform.

FIG. 14 depicts operation of a computer vision platform with the use of virtual objects.

FIG. 15 depicts a computer vision method.

### DETAILED DESCRIPTION OF THE INVENTION

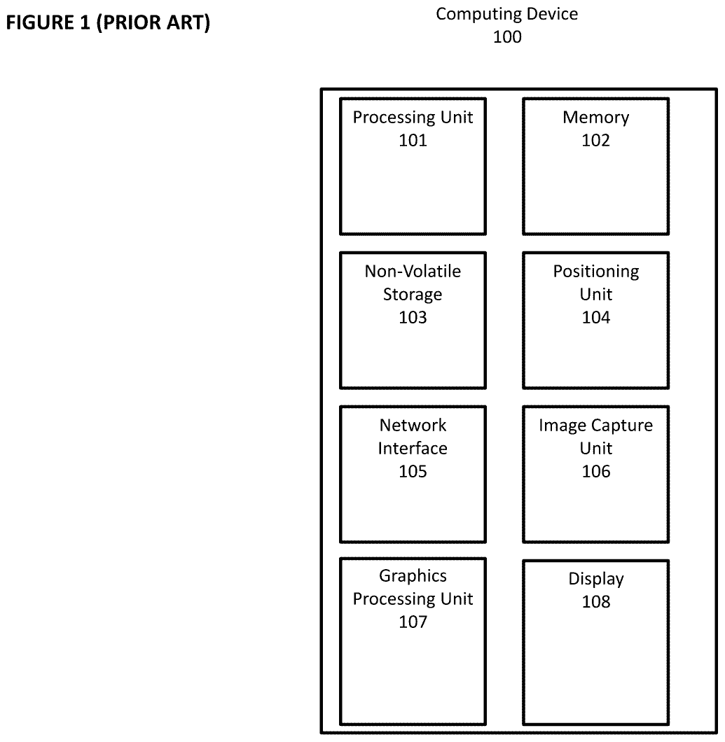

FIG. 1 depicts hardware components of exemplary computing device 100. These hardware components are known in the prior art. Computing device 100 is a computing device that comprises processing unit 101, memory 102, non-volatile storage 103, positioning unit 104, network interface 105, image capture unit 106, graphics processing unit 107, and display 108. Computing device 100 can be a server, client, notebook computer, desktop computer, game system, smartphone, or other computing device. Computing device 100 can be cloud-based, local, or a combination of the two.

Processing unit 101 optionally comprises a microprocessor with one or more processing cores. Memory 102 optionally comprises DRAM or SRAM volatile memory. Non-volatile storage 103 optionally comprises a hard disk drive or flash memory array. Positioning unit 104 optionally comprises a GPS unit or GNSS unit that communicates with GPS or GNSS satellites to determine latitude and longitude coordinates for computing device 100, usually output as latitude data and longitude data. Network interface 105 optionally comprises a wired interface (e.g., Ethernet interface) or wireless interface (e.g., 3G, 4G, 5G, GSM, 802.11, protocol known by the trademark “Bluetooth,” etc.). Image capture unit 106 optionally comprises one or more standard cameras (as is currently found on most smartphones and notebook computers). Graphics processing unit 107 optionally comprises a controller or processor for generating graphics for display, for performing mathematical operations, and as an engine for machine learning. Display 108 displays the graphics generated by graphics processing unit 107, and optionally comprises a monitor, touchscreen, or other type of display. Many types of functions can be performed by either processing unit 101 or graphics processing unit 107 or both.

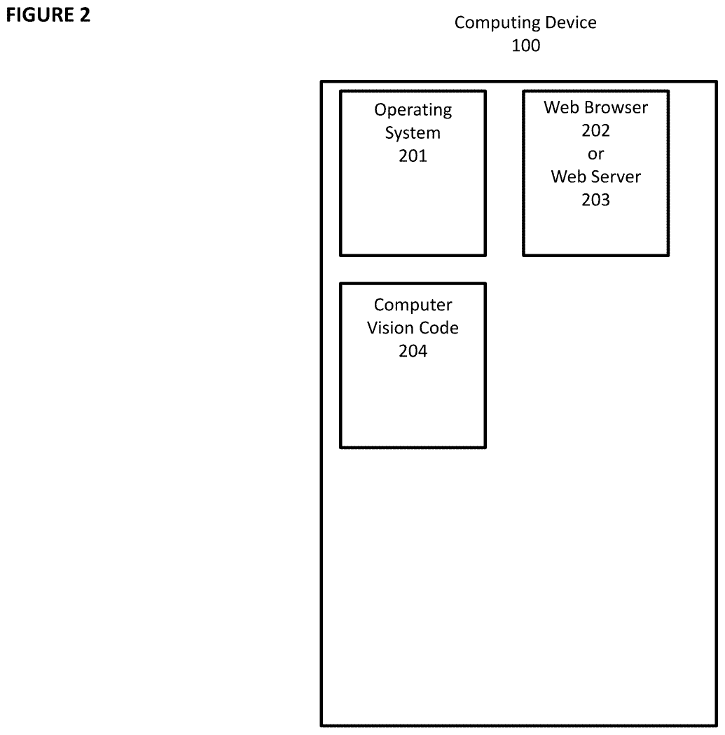

FIG. 2 depicts software components of computing device 100. Computing device 100 comprises operating system 201 (such as the operating systems known by the trademarks “WINDOWS,” “LINUX,” “ANDROID,” “IOS,” or others if computing device 100 is a client, or “WINDOWS SERVER,” “MAC OS X SERVER,” “LINUX,” or others if computing device 100 is a server), web browser 202 if computing device 100 is a client or web server 203 if computing device 100 is a server, and computer vision code 204. Computer vision code 204 comprises lines of software code executed by processing unit 101 or graphics processing unit 107 or both and optionally comprises some or all of the software code for computer vision platform 400, described below.

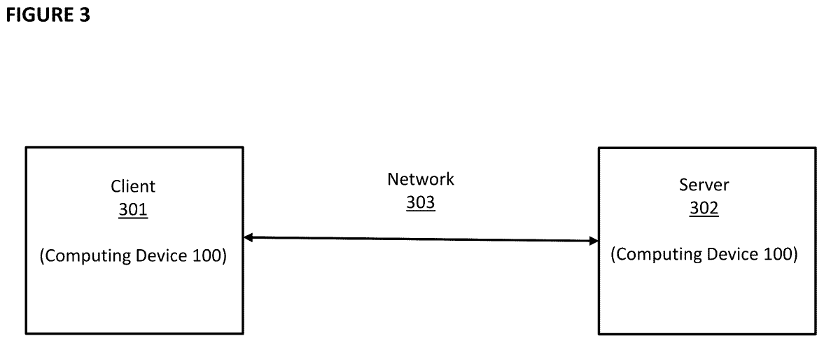

FIG. 3 depicts an exemplary system comprising two computing devices 100, designated as client 301 and server 302. Client 301 and server 302 communicate over network 303. Server 302 is a functional representation, and one of ordinary skill in the art will appreciate that server 302 can be implemented using a single server or multiple servers. For example, server 302 could comprise multiple servers in a cloud computing environment.

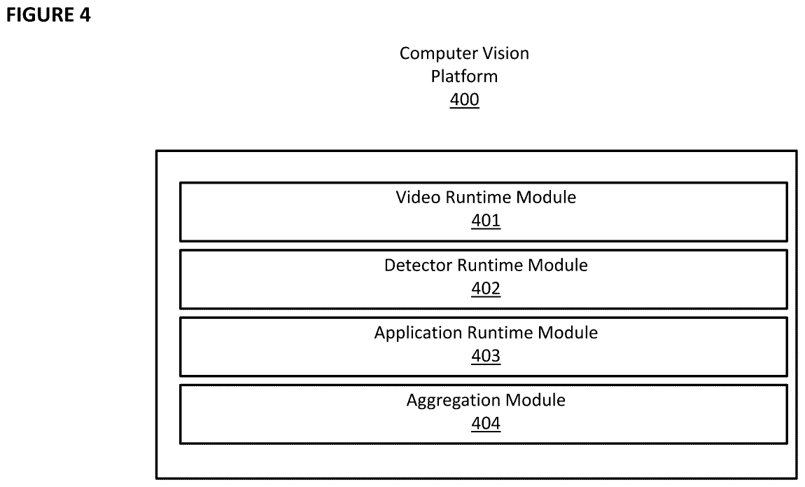

FIG. 4 depicts computer vision platform 400. Computer vision platform 400 comprises video runtime module 401, detector runtime module 402, application runtime module 403, and aggregation module 404, each of which comprises lines of code to be executed by processing unit 101, graphics processing unit 107, or another processing device. Video runtime module 401, detector runtime module 402, application runtime module 403, and aggregation module 404 can be contained wholly within client 301, wholly within server 302, or split in any manner between client 301 and server 302, or between multiple instances of client 301 and/or multiple instances of server 302. It is to be understood that the functions described herein as being performed by video runtime module 401, detector runtime module 402, application runtime module 403, and aggregation module 404 could instead be performed by a different number of modules, and the division of functions and relationships among video runtime module 401, detector runtime module 402, application runtime module 403, and aggregation module 404 are merely illustrative.

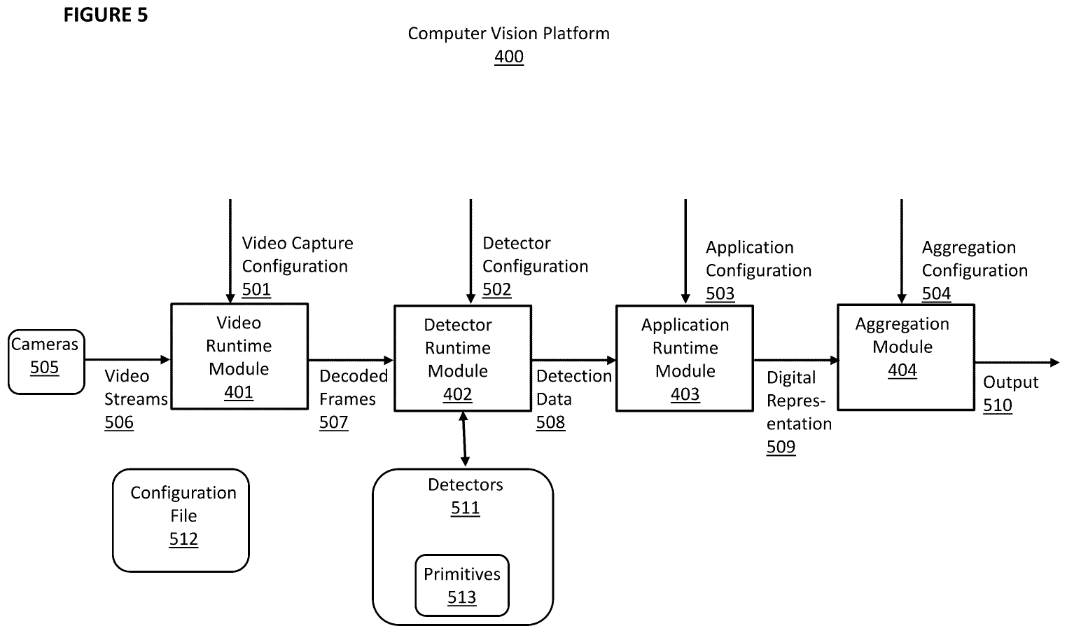

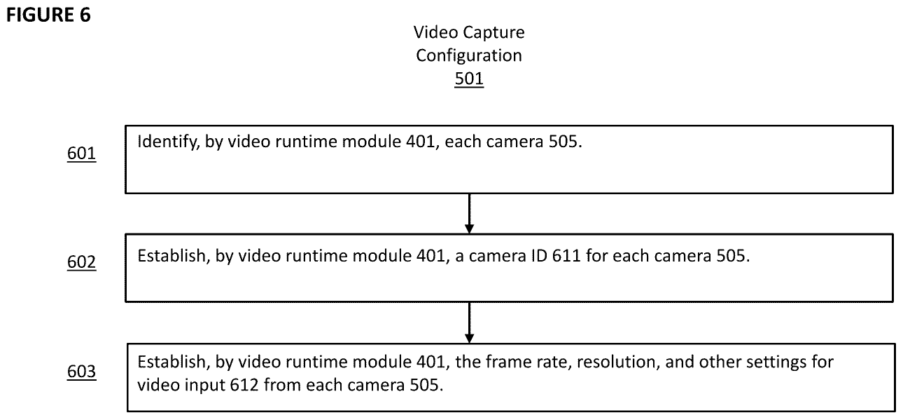

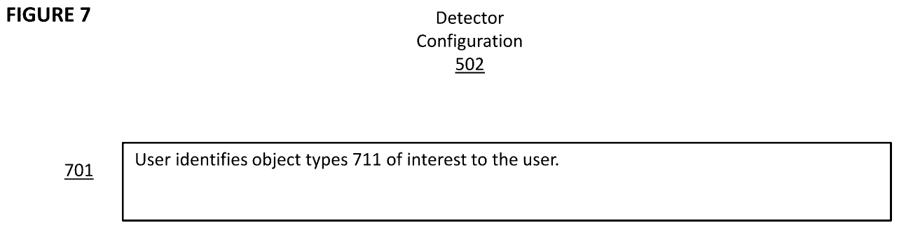

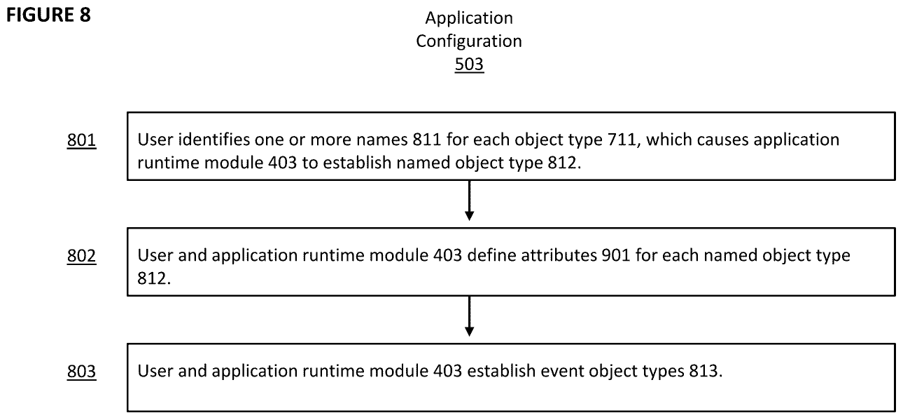

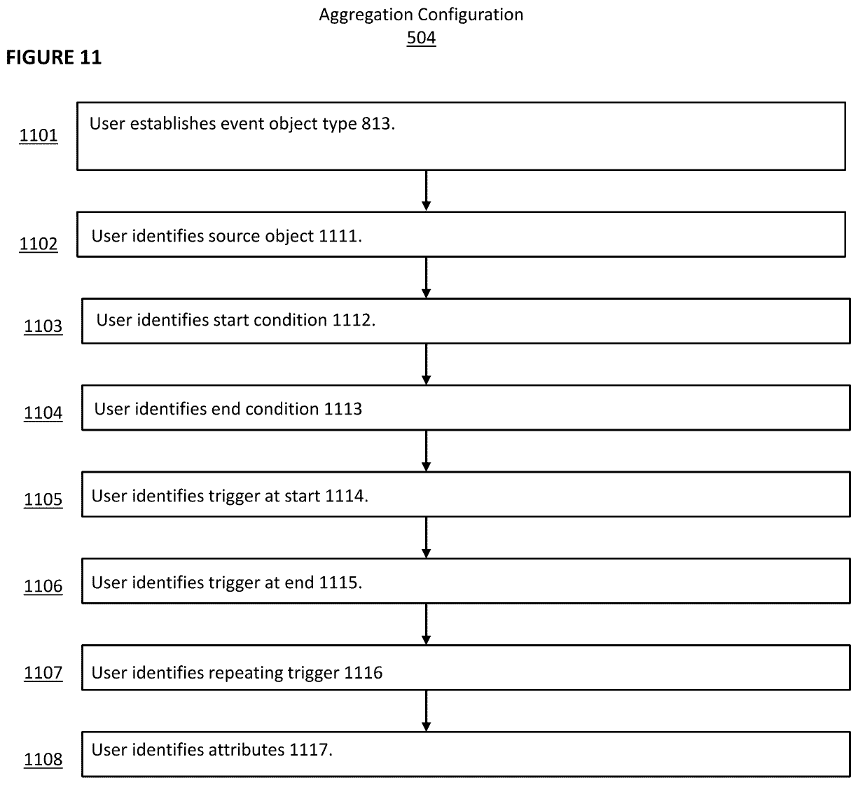

FIG. 5 depicts additional aspects of exemplary computer vision platform 400. Video runtime module 401 is configured by video capture configuration method 501, described below with reference to FIG. 6. Detector runtime module 402 is configured by detector configuration method 502, described below with reference to FIG. 7. Application runtime module 403 is configured by application configuration method 503, described below with reference to FIG. 8. Aggregation module 404 is configured by aggregation configuration method 504, described below with reference to FIG. 11. Optionally, video capture configuration method 501, detector configuration method 502, application configuration method 503, and aggregation configuration method 504 result in the generation of configuration file 512 that is used by computer vision platform 400 prior to and during operation thereafter.

Cameras 505 are located in a physical space and capture video streams 506, which are provided to video runtime module 401. Cameras 505 can comprise image capture units 106 in computing devices 100, stand-alone camera units, or any other device that is able to capture sequences of images over time.

Video runtime module 401 decodes video streams 506 into decoded frames 507, which are provided to detector runtime module 402. Depending on the settings established during video capture configuration method 501, video runtime module 401 can provide detector runtime module 402 with all decoded frames 507 generated from video streams 506, or video runtime module 401 instead can provide detector runtime module 402 with only a subset of all decoded frames 507 generated from video streams 506. For example, if a video stream 506 results in 30 decoded frames per second, video runtime module 401 optionally could provide only a sample of the decoded frames, such as 1/30^{th} of all decoded frames, meaning one decoded frame per second. Similarly, depending on the settings established during video capture configuration method 501, video runtime module 401 can provide detector runtime module 402 with decoded frames 507 using the pixel resolution generated by cameras 505, or video runtime module 401 instead can scale the images in video streams 506 to provide decoded frames 507 with a lower pixel resolution than was generated by cameras 505.

Reducing the number of frames and/or the resolution may result in sufficient precision for the user's purpose. For example, if the user is a manager of a restaurant, analyzing one frame per second from each camera 505 with a resolution of 1024×768 instead of 30 frames per second with a resolution of 4096×2160 might be more than enough data to identify and track persons in the restaurant and relevant activity at individual tables. The user's purpose, of course, is not limited to a restaurant context and can be any conceivable type of business where a digital representation can be formed for physical objects detected by one or more cameras.

Video runtime module 401 optionally can perform the following functions as well: provide control functionality for cameras 505; record video streams from one or more cameras 505; buffer frames from video streams 506; and determine where to route decoded frames 507. For example, detector runtime module 402 might be implemented in multiple physical servers with different addresses.

Detector runtime module 402 analyzes one or more decoded frames 507 that correspond to a relatively short period of time (e.g., in the restaurant example, one second, as people and items will not often change state in periods shorter than one second). This essentially is a static snapshot of a physical space. Detector runtime module 402 identifies physical objects in the one or more frames and outputs detection data 508, which is provided to application runtime module 403 on a continuing basis, such that changes in decoded frames 507 can result in changes in detection data 508 in real-time. For example, if detector runtime module 402 is receiving and analyzing one frame 507 per second, it might update detection data 508 once per second.

As used herein, a “physical object” is an object that exists in the physical world and in digital images captured by video runtime module 401. After detector runtime module 402 detects the physical object, it will be referred to as a “detected object.” The term “object” can refer to either the physical object, the detected object, or digital objects associated with either the physical object or the detected object.

Once detector runtime module 402 identifies a physical object in one or more decoded frames, it assigns a unique object with a unique object ID to the detected object. Thereafter, the same object and object ID are used for that detected object when detection data 508 is updated in subsequent frames.

Detector runtime module 402 executes detectors 511 designed and optimized to detect various types of physical objects in decoded frames 507. A physical object that can be detected by detector runtime module 402 can be referred to as a primitive 513. Detector runtime module 402 also identifies interactions between different detected objects. For example, one detector 511 might detect a person in decoded frame 507, and another detector 511 might detect a package in decoded frame 507, while still another detector 511 is able to detect that the person is holding the package by understanding come characteristic of person (e.g., persons can hold packages in their arms) or that the person is near the package or is looking toward the package. Detectors 511 can utilize any type of computer vision technique, such as those that utilize machine learning, artificial neural networks, known machine vision techniques, heuristic techniques, or other techniques.

In the instance where a detector 511 uses machine learning techniques, the detector 511 can utilize machine learning models, where each machine learning module is trained to detect a primitive 513, such as a person or a table.

Detector runtime module 402 optionally can perform the following functions as well: optimize the processing of decoded frames 507 by identifying duplicate or redundant data sources (e.g., if two cameras are capturing images of the same objects); perform facial recognition on persons who appear in decoded frames 507; and perform identification of other objects (such as identifying a car by license plate) that appear in decoded frames 507.

Application runtime module 403 receives detection data 508 from detector runtime module 402 on an ongoing basis and tracks detected objects over time and through the lifecycle of each detected object as detection data 508 changes. Optionally, application runtime module 403 stores each version of detection data 508 that it receives so that it can analyze changes between frames as time elapses.

Application runtime module 403 can track a detected object over time among frames until the detected object disappears from a sequence of decoded frames for more than a predetermined threshold (such as a number of decoded frames or an elapsed time). In the example of a restaurant, this means that application runtime module 403 would track a customer from the moment he or she first appears in a decoded frame until a certain amount of time or frames after he or she no longer appears in a decoded frame. Thus, detector runtime module 402 analyzes an individual frame (or a discrete set of frames over a short amount of time), while application runtime module 403 analyzes sequences of frames and tracks detected objects during the entire lifecycle of each object.

Detector runtime module 402 and application runtime module 403 will track the detected object and know that it is the same object. To do so, detector runtime module 402 utilizes machine learning models and heuristics to understand that the same object is appearing in a sequence of decoded frames 507. Application runtime module 403 applies lifecycle rules and analyzes detected attributes of the objects. For example, after analyzing a sequence of decoded frames 507, application runtime module 403 could conclude the following: “The detected object is a person; the object belongs to the object class “Waiter,” and it is the same waiter that has appeared in M previous decoded frames for N amount of time with object ID X and attributes Y and Z.”

Application runtime module 403 identifies events and state changes based on detection data 508 and changes over time to detection data 508 and generates digital representation 509 to capture such changes. Application runtime module 403 implements business logic identified by the user during application configuration method 503.

Optionally, computer vision platform 400 can comprise multiple instances of detector runtime module 402 (such as one instance of detector runtime module 402 for each camera 505), and application runtime module 403 can receive and analyze data from those multiple instances of detector runtime module 402 to provide a single unified digital representation of a physical space. Application runtime module 403 is able to correlate data from multiple cameras 505 (whether cameras 505 overlap of not) into a single unified digital representation 509 of a physical space. Optionally, computer vision platform 400 can also comprise multiple instances of video runtime module 402 (such as one instance of video runtime module 402 per camera 505). In addition, application runtime 403 could be clustered, where a cluster of computing devices 100 operates a unified application runtime 403.

Aggregation module 404 receives digital representation 509 and generates output 510. Aggregation module 404 enables real-time queries, such as through APIs, regarding the current dynamic state indicated by digital representation 509. Aggregation module 404 also enables real-time update notifications, such as through APIs, a dashboard, reports, or alerts, of the dynamic state as indicated by digital representation 509. Aggregation module 404 also enables querying of time-series data, as opposed to the current state, as indicated by digital representation 509 over time. Additionally, aggregation module 404 optionally provides a user interface by which a user can control other components.

FIG. 6 depicts video capture configuration method 501. First, video runtime module 401 identifies each camera 505 that is available to it (step 601). Video runtime module 401 can do this by discovering the camera 505 itself or by receiving input from a user about camera 505. Second, video runtime module 401 establishes a camera ID 611 for each camera 505 (step 602). Third, video runtime module 401 establishes the frame rate and resolution for video input 612 to be received from cameras 505, the desired frame rate and resolution for decoded frames 507 to be output by video runtime module 401, and other settings that govern the generation of decoded frames 507 from video streams 506 (step 603). Video runtime module 401 can do this based on instructions received from the user, based on its own decision making, or based on user input in response to recommendations it provided to the user.

FIG. 7 depicts detector configuration method 502 (step 701). The user identifies object types 711 of interest to the user. For example, a user operating a restaurant might be interested in people, tables, plates, and utensils.

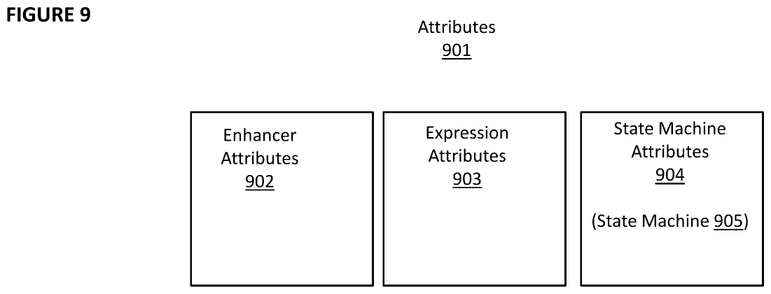

FIG. 8 depicts application configuration method 503. First, the user identifies one or more names 811 for each object type 711 (e.g., “Waiter” or “Diner” for a Person), which causes application runtime module 403 to establish named object type 812 (step 801). Second, the user and application runtime module 403 define attributes 901 (discussed in detail below with reference to FIG. 9) for each named object type 812 (step 802). Third, the user and application runtime module 403 establish event object types 813 (discussed in detail below with reference to FIG. 11) (step 803).

FIG. 9 depicts attributes 901 established for each named object type 812 during detector configuration method 502 and application configuration method 503. Attributes 901 comprises enhancer attributes 902, expression attributes 903, and state machine attributes 904. These types of attributes are exemplary, and other types of attributes can be established for any given named object type 812.

An enhancer attribute 902 is a generally intrinsic attribute about a detected object. For example, if the detected object is a person, enhancer attributes 902 might include facial hair, eye color, facial expression, age, height, etc. Thus, enhancer attributes 902 generally include attributes that can be discerned through analysis of a decoded frame 507.

Expression attributes 903 are attributes that are definitional, rule-based, or formulaic regarding an object of named object type 812, and can include attributes that can be derived using other attributes or information. Examples of expression attributes 903 might include “Object is Adult” (which is derived based on an enhancer attribute 902 for age), “Object is Child,” (same) “Object sat down at time X,” (which can be derived based on a timestamp for a decoded frame 507 when the detected object was identified as sitting down), etc.

One type of expression attribute 903 is a relationship attribute, which is an expression that relate two objects together. For example, one object might represent a table and another object might represent a diner. An expression attribute 903 would indicate that the diner is sitting at the table. An object of type “table” might have an attribute called “diners” that is a list of all the diner objects that are at that table, as defined by the relationship expression, which might be defined as “sitting and within X distance of the table”. Importantly, attributes can rely upon relationships in other expressions and state machines, i.e. “table.diners.length>0” or “any(table.diners.age)<18”, etc.

State machine attributes 904 are attributes that implement state machine 905 to reflect a state of a detected object.

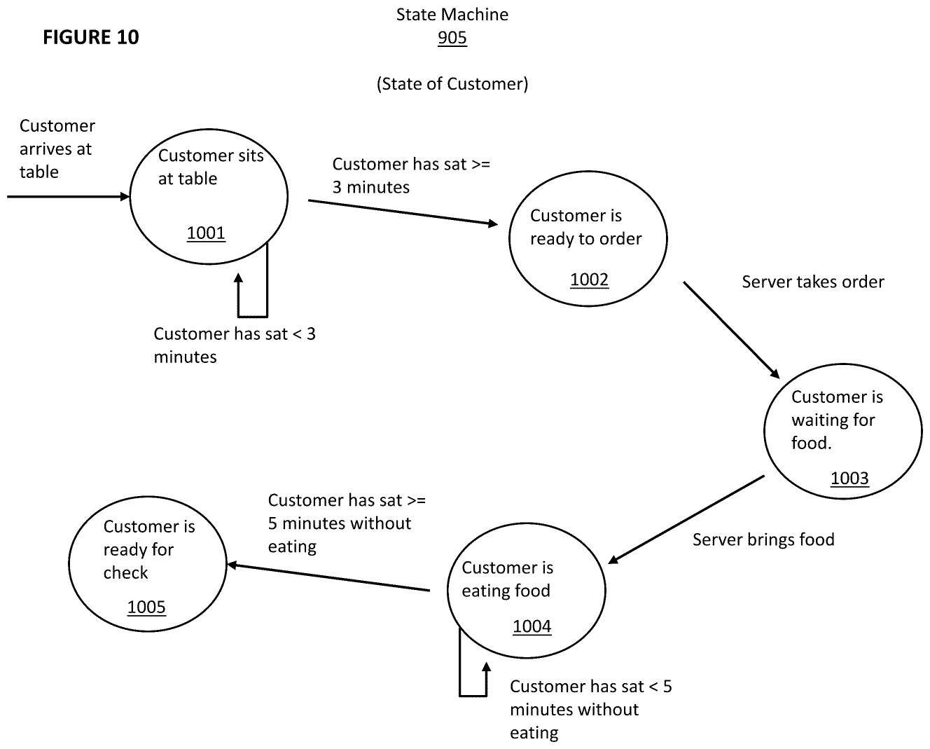

FIG. 10 depicts exemplary state machine 905 that can be created as part of a state machine attribute 904. This example represents the state of a customer in a restaurant, where the customer is a detected object. In this example, there are five possible states for the customer when he or she is seated at a table in physical space.

State machine 905 is invoked when a customer arrives at the table. Transition rules between states in state machine 905 can be based on expression attributes.

In state 1001, the customer sits at the table. In state machine 905, the changes between states can be triggered by changes to expression attributes 903 in detection data 508. For example, if the customer has sat at the table for less than 3 minutes, he or she remains in state 1001. If the customer has sat at the table for 3 minutes or more, the customer enters state 1002, where the customer is ready to order. The customer remains in state 1002 until the server takes the customer's order, at which point the customer enters state 1003, where the customer is waiting for food. The customer remains in state 1003 until the server brings the customer's food to the table, at which point the customer enters state 1004, where the customer eats the food. The customer remains in state 1004 as long as he or she has sat for less than 5 minutes without eating. If the customer has sat for 5 minutes or more without eating, the customer enters state 1005, where the customer is waiting for the check.

State machine 905 is a simple example to illustrate the functionality of state machines and state machine attributes 904. A real-life implementation might comprise many state machines 905, each of which could be more or less complex than state machines 905 shown in FIG. 10.

FIG. 11 depicts additional detail regarding event object type 813 and aggregation configuration 504. The user first establishes an event object type 813 (step 1101). An example of an event object type 813 might be detecting when a person sits at a table. The user then identifies one or more of the following for the event object type: source object 1111 (the object that the event was fired from) (step 1102); a start condition 1112 (step 1103); an end condition 1113 (step 1104); a trigger at start 1114 (step 1105); a trigger at the end 1115 (step 1106); a repeating trigger 1116 that repeats at a set interval for as long as the event is active (step 1107); and attributes 1117 (step 1108).

A trigger is an action that can be taken. For example, a trigger can be defined using “if-then”. Triggers (such as triggers at start 1104, triggers at end 1105, and repeating triggers 1106) can include providing information to a user or device, such as through output 510.

Attributes 1117 can comprise expression attributes 903, that are stored (enabling computer vision platform 400 to store attributes during the event, which may no longer be the same value after the event is done-for example, diners at a table during a single dining session, versus when the next group sits down). During operation, an instantiation of an event object type 813 will be created upon the meeting of a start condition 1112 from a source object 1111 and continue to exist until the end condition 1113 occurs, meaning that the instantiation can be temporary. An example of an event object type 813 that has a start condition 1112 but not an end condition 1113 would be the arrival of food at a table, whereas an example of an event object type 813 that has a start condition 1112 and an end condition 1113 is an entire dining session.

Table 1 depicts examples of event object types 813 and triggers at end 1114, 1115, and 1116, where underlined items are objects 713 that are source objects 1111:

TABLE 1
Examples of Event Object Types 813 and Triggers

| Event Object Type 813 | Triggers At Start, End, or Repeating |
|---|---|
| Diner X sits at Table Y | Update Dashboard |
| | Send Alert to Server Z |
| Diner X has sat at Table Y for | Update Dashboard |
| greater than or equal to 3 | Send Alert to Server Z and Manager |
| minutes | |

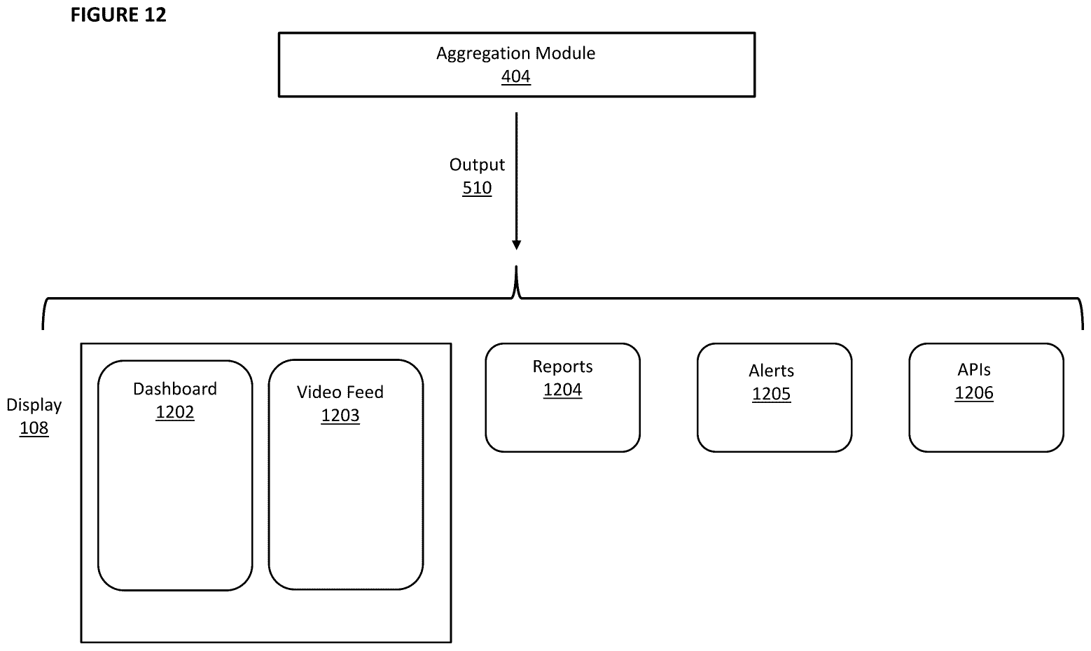

FIG. 12 depicts aggregation module 404 generating output 510 as part of action 1112. Output 510 comprises data used to populate the display of dashboard 1202 and video feed 1203 shown on display 108 of a computing device (such as client 301). Data in output 510 can be used to generate reports 1204 and alerts 1205 and it can be accessed through APIs 1206 and provided as an event stream via APIs 1206.

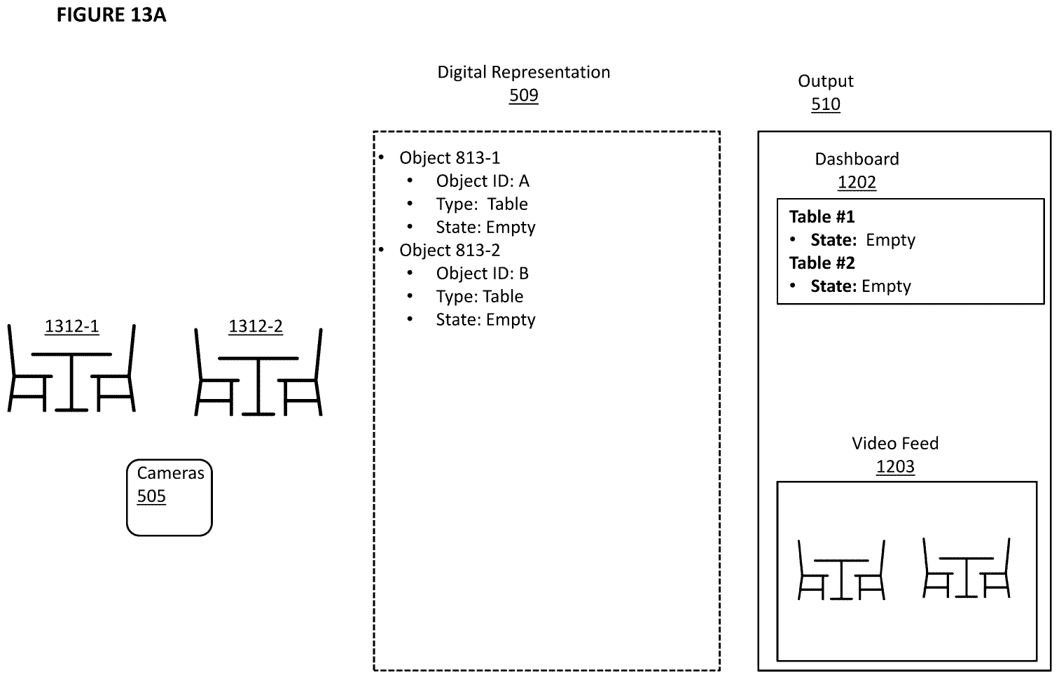

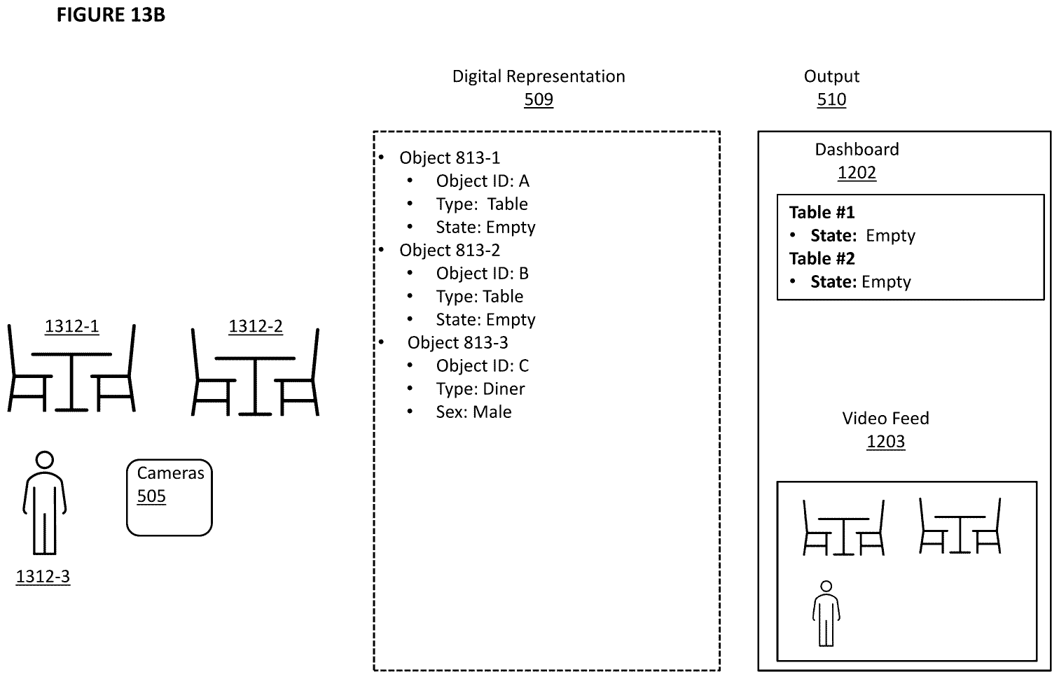

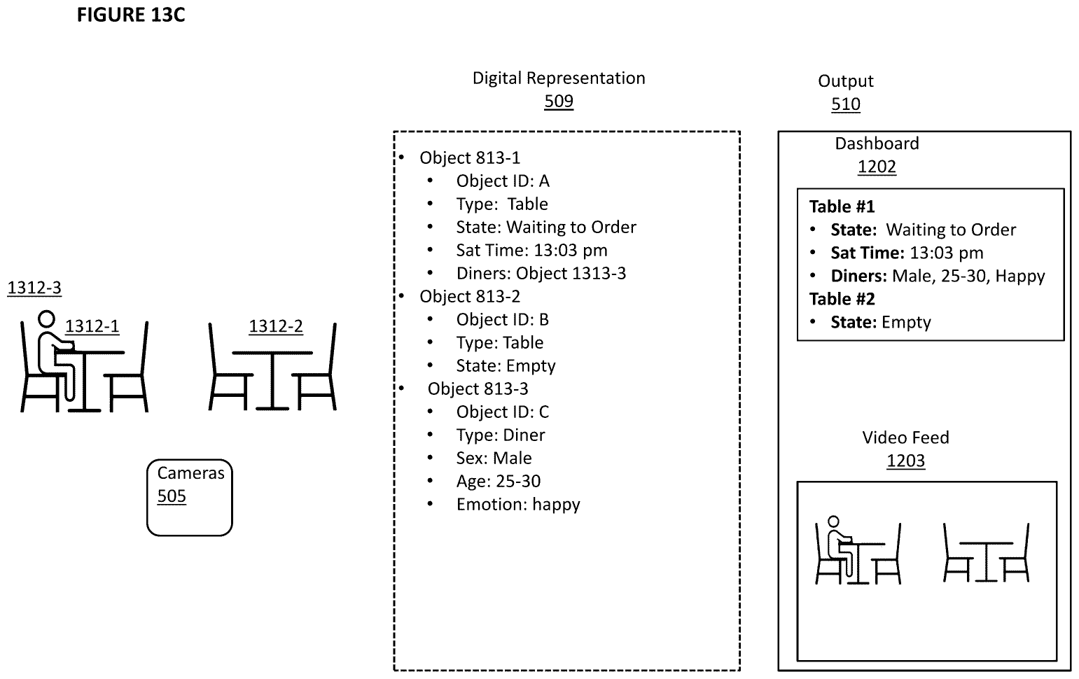

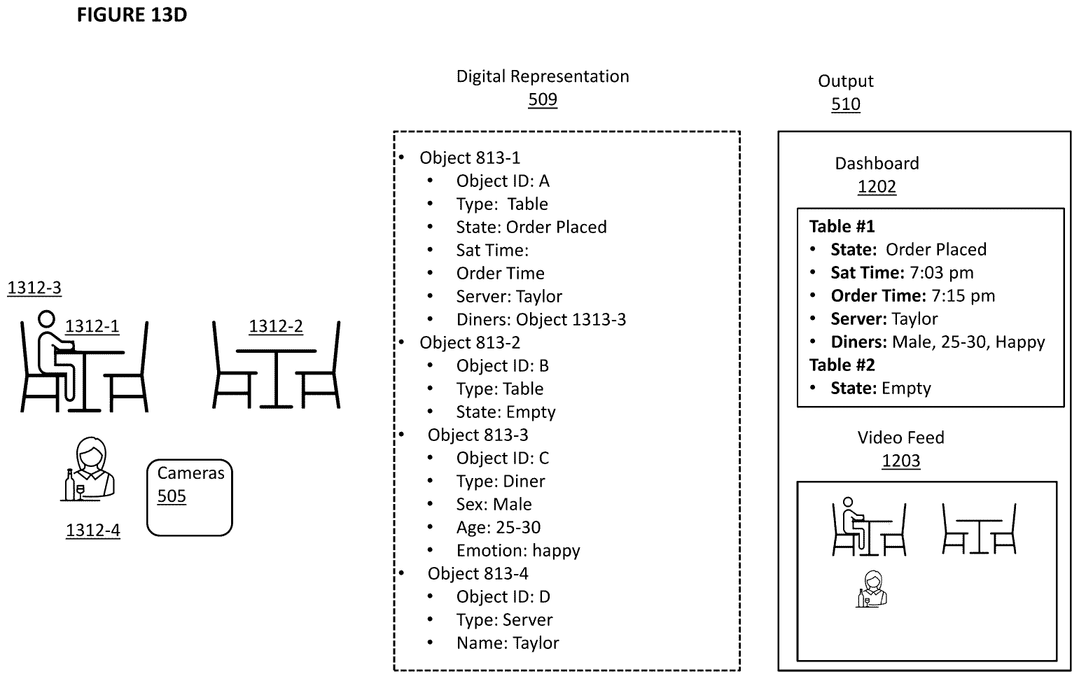

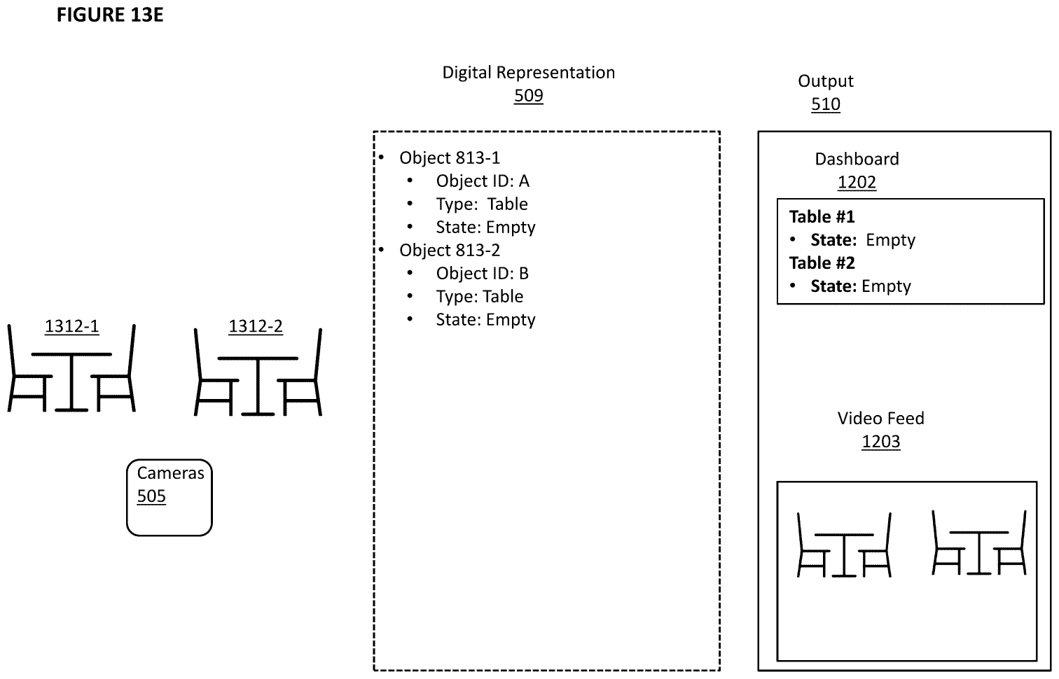

FIGS. 13A-13E depict an exemplary sequence of events within a physical space and the consequent changes in digital representation 509 and output 510. The physical space here comprises a portion of a restaurant, and specifically comprises physical object 1312-1 (a table), physical object 1312-2 (another table), and cameras 505. Digital representation 509 is generated to capture the objects of interest in physical space, and digital representation 509 is made available via output 510, such as through APIs or a dashboard display.

The activities of video runtime module 401 and decoded frames 507 are not shown in FIGS. 13A-13E because those items can be understood through the previous discussion.

In FIG. 13A, tables 1312-1 and 1312-2 are empty. Digital representation 509 comprises objects 813-1 and 813-2 corresponding to tables 1312-1 and 1312-2, respectively, and indicate a status of “Empty.” Here, objects 813-1 and 813-2 are instantiations of named object type 812 for a table, where the named object type 812 for a table was established during application configuration method 503 discussed in FIG. 8. Output 510 comprises dashboard 1202, which indicates the tables are empty, and video feed 1203 that shows a view of physical space from one of the cameras 505.

In FIG. 13B, customer 1312-3 has entered the physical space and is nearing table 1312-1. Digital representation 509 is updated to include object 813-3 for customer 1312-3, where object 813-3 is an instantiation of named object type 812 for a diner By comparing the image of person 1312-3 against stored primitives, detector runtime module 402 is able to determine that customer 1312-3 is a male and is a diner (as opposed to a server) based on his style of dress, the lack of an identifying characteristic (such as a nametag, uniform, apron, napkin over an arm, color scheme of dress, etc.), or other criteria. Notably, object 813-1 is still used for table 1312-1 and object 813-3 is still used for table 1312-2, as there is a semi-persistent mapping between each physical object and an object until the physical object no longer appears in decoded frames 507 for more than a predetermined threshold of frames or time.

In FIG. 13C, diner 1312-3 (corresponding to object 1313-3) has sat down at table 1312-1. The attributes of objects 813-1 and 813-3 are updated accordingly, as is dashboard 1202.

In FIG. 13D, server 1312-4 (named Taylor) approaches table 1312-1 and takes the order of diner 1312-3. The attributes of objects 813-1 and 813-3 are updated accordingly, as is dashboard 1202. Object 813-4 has been added to digital representation 509 because server 1312-4 is in the decoded frame, where object 813-4 is an instantiation of named object type 813 for a server.

In FIG. 13E, both server 1312-4 and diner 1312-3 have left the physical space. After server 1312-4 and diner 1312-3 do not appear in decoded frames 507 for more than a predetermined threshold (in terms of number of decoded frames or elapsed time), then objects 813-4 and 813-3 are removed from digital representation 509. Dashboard 1202 also has been updated.

As can be seen in FIGS. 13A-13E, computer vision platform 400 identifies a physical object when it first appears in a decoded frame and it continues to track that physical object in subsequent decoded frames until the physical object no longer appears in the decoded frames for a predetermined threshold (e.g., 30 frames or 5 seconds).

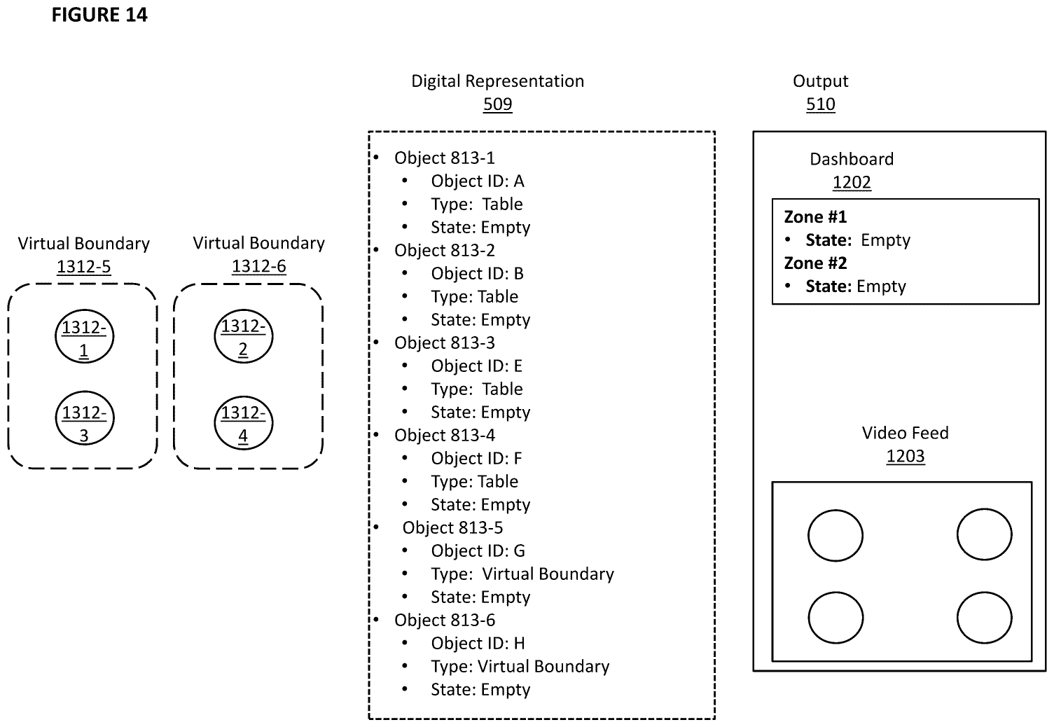

Optionally, during detector configuration method 502, a user can establish virtual objects in physical space. For example, in FIG. 14, the same restaurant scenario from FIGS. 13A-13E is depicted. Here, the user has established virtual boundary 1312-5 and virtual boundary 1312-6, which are zones in which tables 1312-1, 1312-2, 1312-3, and 1312-4 are located. Virtual boundaries 1312-5 and 1312-6 are abstractions generated by detector runtime module 402 and do not physical appear in the physical space. Digital representation 509 contains objects 813-5 and 813-6 for virtual boundaries 1312-5 and 1312-6, and dashboard 1202 has been configured to provide information about Zone #1 (virtual boundary 1312-5) and Zone #2 (virtual boundary 1312-6) rather than on individual tables. Objects 813-5 and 813-6 are instantiations of named object type 812 for a virtual boundary.

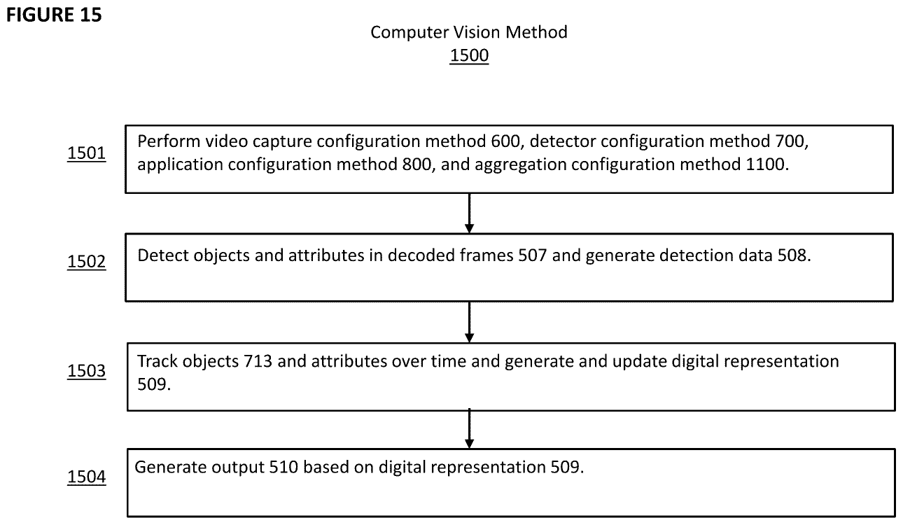

FIG. 15 depicts computer vision method 1500, which is an example of a sequence of events during configuration and operation of computer vision platform 400.

First, configuration is performed, comprising video capture configuration method 600, detector configuration method 700, application configuration method 800, and aggregation configuration method 1100 (step 1501).

Second, objects and attributes are detected in decoded frames 507, and detection data 508 is generated (step 1502).

Third, objects 713 and attributes are tracked over time, and digital representation 509 is generated and updated (step 1503).

Fourth, output 510 is generated based on digital representation 509 (step 1504).

It should be noted that, as used herein, the terms “over” and “on” both inclusively include “directly on” (no intermediate materials, elements or space disposed therebetween) and “indirectly on” (intermediate materials, elements or space disposed therebetween). Likewise, the term “adjacent” includes “directly adjacent” (no intermediate materials, elements or space disposed therebetween) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements therebetween, as well as forming the element indirectly on the substrate with one or more intermediate materials/elements there between.

What is claimed is:

1. A computer vision method, comprising:
receiving video frames over a period of time from one or more cameras;
detecting objects and associated attributes in the video frames;
establishing a digital representation of the objects and associated attributes;
tracking the objects and associated attributes across the video frames over the period of time and updating the digital representation in real-time; and
performing an action in response to a triggering event in the digital representation.

2. The method of claim 1, wherein one or more of the associated attributes are enhancer attributes.

3. The method of claim 1, wherein one or more of the associated attributes are expression attributes.

4. The method of claim 1, wherein one or more of the associated attributes are state machine attributes.

5. The method of claim 1, further comprising:
prior to the detecting step, receiving information from a user as to types of objects to be detected.

6. A computer vision method, comprising:
receiving video frames over a period of time from one or more cameras;
detecting objects and associated attributes in the video frames;
establishing a digital representation of the objects and associated attributes;
tracking the objects and associated attributes across the video frames over the period of time and updating the digital representation; and
transmitting, by a first computing device, some or all of the digital representation to a second computing device through an API.

7. The method of claim 6, wherein one or more of the associated attributes are enhancer attributes.

8. The method of claim 6, wherein one or more of the associated attributes are expression attributes.

9. The method of claim 6, wherein one or more of the associated attributes are state machine attributes.

10. The method of claim 6, further comprising:
prior to the detecting step, receiving information from a user as to types of objects to be detected.

11. A computer vision system, comprising:
one or more processing units;
memory; and
a set of instructions stored in memory and executable by the one or more processing units to:
receive video frames over a period of time from one or more cameras;
detect objects and associated attributes in the video frames;
establish a digital representation of the objects and associated attributes;
track the objects and associated attributes across the video frames over the period of time and updating the digital representation in real-time; and
perform an action in response to a triggering event in the digital representation.

12. The system of claim 11, wherein one or more of the associated attributes are enhancer attributes.

13. The system of claim 11, wherein one or more of the associated attributes are expression attributes.

14. The system of claim 11, wherein one or more of the associated attributes are state machine attributes.

15. The system of claim 11, wherein the set of instructions comprises instructions to:
receive information from a user as to types of objects to be detected.

16. A computer vision system, comprising:
one or more processing units;
memory; and
a set of instructions stored in memory and executable by the one or more processing units to:
receive video frames over a period of time from one or more cameras;
detect objects and associated attributes in the video frames;
establish a digital representation of the objects and associated attributes;
track the objects and associated attributes across the video frames over the period of time and updating the digital representation; and
transmit some or all of the digital representation through an API.

17. The system of claim 16, wherein one or more of the associated attributes are enhancer attributes.

18. The system of claim 16, wherein one or more of the associated attributes are expression attributes.

19. The system of claim 16, wherein one or more of the associated attributes are state machine attributes.

20. The system of claim 16, wherein the set of instructions comprises instructions to:
receive information from a user as to types of objects to be detected.
